(19) United States
(12) Patent Application Publication
(10) Pub. No.: US 2011/0099340 A1
(43) Pub. Date: Apr. 28, 2011

(54) MEMORY ACCESS CONTROL DEVICE AND METHOD THEREOF

(75) Inventor: Noriyuki Funakubo, Hamamatsu-shi (JP)

(73) Assignee: YAMAHA CORPORATION, Hamamatsu-shi (JP)

(21) Appl. No.: 12/912,921

(22) Filed: Oct. 27, 2010

(30) Foreign Application Priority Data
Oct. 27, 2009 (JP) 2009-247124

(51) Int. Cl. G06F 13/00

(52) U.S. Cl. 711/154; 711/E12.001

(57) ABSTRACT

A memory access control device and method is provided with a cache memory having a plurality of cache areas, each for storing image data of one macroblock, and a cache table having a plurality of table areas, corresponding to the plurality of cache areas, each for storing a scheduled access counter that counts the number of scheduled accesses to a corresponding cache area and an in-frame address of image data of one macroblock stored in the corresponding cache area. A data request processor receives a data request including specification of an in-frame occupation region of the requested image data from the image processor, determines target image data of at least one macroblock required to process requested image data based on the in-frame occupation region of the requested image data, acquires the target image data from the cache memory, processes the image data requested by the data request using the acquired image data, and outputs the processed image data to the image processor.

### BACKGROUND OF THE INVENTION

1. Technical Field of the Invention

The present invention relates to a memory access control device, as well as a method, suitable for an image processor such as a moving image decoder, which performs decoding of compressed data of a moving image using an external memory.

2. Description of the Related Art

A moving image decoder, which performs decoding of compressed moving image data such as Moving Picture Experts Group (MPEG) data, stores decoded image data of a previous framed in a frame memory and performs a decoding process of a current frame while accessing the frame memory. In the case where encoded data such as encoded data of a predictive frame (P frame), which was encoded through an inter-frame prediction encoding process, is subjected to a decoding process, image data in a prior frame which was referenced for encoding the P frame is needed for the decoding process. In this case, the decoding process of the encoded data of the P frame is performed in units of macroblocks, each including a predetermined number of pixels, and image data in a reference frame including image data used for encoding a macroblock is needed to decode the macroblock. Here, the same image data in the reference frame is used for the decoding process of the P frame a plurality of times throughout the entire decoding process. Thus, if image data of a reference frame used for the decoding process is read from the frame memory each time, the same image data is read from the frame memory a plurality of times so that a large amount of image data is read from the frame memory per unit time.

The frame memory generally has a large capacity and a low read speed. Thus, when a large amount of image data is read from the frame memory per unit time, all required image data may not be read in the worst case. If the moving image decoder reads a large amount of image data from the external memory per unit time in a system in which the moving image decoder shares the external memory with another module and some area of the external memory are used as a frame memory, the speed at which another module reads data from the external memory is lowered, thereby reducing system performance.

In a variety of technologies suggested to overcome this problem (for example, see Patent References 1 and 2), a cache memory is provided in a moving image decoder and image data read from an external memory for decoding process is stored in the cache memory and, when the same image data as image data stored in the cache memory is needed twice or more for decoding process, the same image data is not read from the external memory.

[Related Art References]

[Patent Reference 1] Japanese Patent Application Publication No. 2006-41898

[Patent Reference 2] Japanese Patent Application Publication No. 2008-66913

To efficiently transmit image data, which is required by the moving image decoder, from the external memory to the moving image decoder through cache control, there are performed a first process, in which image data which is not stored in the cache memory among the image data required by the moving image decoder is read from the external memory and the read image data is then stored in the cache memory, and a second process, in which the image data required by the moving image decoder is read from the cache memory and the read image data is then provided to the moving image decoder. However, the first process and the second process are not synchronized with each other and reading of the image data from the external memory in the first process is performed as continuously as possible.

On the other hand, when the cache memory is full of image data transmitted from the external memory in the first process, there is a need to perform so-called removal control so that an area in the cache memory whose image data has already been transmitted is reset as a destination of new image data. However, if the first and second processes are performed asynchronously, image data stored in the cache memory may be set as image data to be removed even when the second process requires the stored image data and the second process for the stored image data has not been completed. If such image data is set as image data to be removed so that it is overwritten with different image data read from the external memory, it is necessary to retransmit the image data, which was set as image data to be removed, from the external memory to the cache memory to perform the second process. This increases the amount of transmission between the external memory and the cache memory and also inhibits access of another module to the external memory, thereby reducing system efficiency.

Therefore, there remains a need for a memory access control device that can perform the first and second processes asynchronously, can prevent image data required by the second process from being set as image data to be removed when the first and second processes are performed asynchronously, and can efficiently provide image data from the external memory to an image processor, such as a moving image decoder. The present disclosure addresses this need.

### SUMMARY OF THE INVENTION

One aspect of the present invention is a memory access control device that can read image data in units of macroblocks, into which one frame is divided, from an external memory storing image data of the one frame, construct (i.e., process) image data requested by an image processor based on the read image data, and provide the processed image data to the image processor as requested image data.

The memory access control device includes a cache memory having a plurality of cache areas, each capable of storing image data of one macroblock and a cache controller having a cache table and a data request processor. The cache table can have a plurality of table areas corresponding to the plurality of cache areas. Each of the plurality of table areas can store a scheduled access counter that counts the number of scheduled accesses to a corresponding cache area and an in-frame address of image data of one macroblock stored in the corresponding cache area.

The data request processor can receive a data request including specification of an in-frame occupation region of the requested image data from the image processor, determine target image data of at least one macroblock required to process the requested image data according to the in-frame occupation region of the requested image data, acquire the target image data from the cache memory, process the requested image data using the acquired image data, and output the processed image data to the image processor.

If the target image data is not stored in the cache memory, the data request processor can select one of the table areas having the scheduled access counter with a value of “0” as an update table area, determine whether the cache area corresponding to the update table area is a destination of the target image data, output a read request instructing transmission of the target image data from the external memory to the corresponding cache area, store the in-frame address of the target image data in the update table area, and increase the scheduled access counter of the update table area by “1”.

If the target image data is stored in the cache memory and the read request for the target image data has not been output, or if the read request for the target image data has been output, the data request processor can increase the scheduled access counter of the table area that stores the in-frame address of the target image data by “1”.

The data request processor can read the target image data of one macroblock required to process the requested image data from one cache area of the cache memory and decrease the scheduled access counter of a table area corresponding to the cache area by “1” when the read image data has been used to process the requested image data.

Each of the plurality of table areas also can store a validity flag indicating validity or an invalidity flag indicating invalidity of the image data in the corresponding cache area.

The data request processor can select the update table that does not store the validity flag and store the validity flag in the update table area when the target image data has been read from the external memory and stored in the corresponding cache area.

If any table area in the cache table does not store both the in-frame address of the target image data and the validity flag, and the scheduled access counter thereof does not have a value of “1” or more, the data request processor can select one of the table areas having the scheduled access counter with a value of “0” as an update table area, store the in-frame address of the target image data in the update table area, increase the scheduled access counter of the update table area by “1”, and output the read request instructing transmission of the target image data from the external memory to the cache area corresponding to the update table area.

If any table area in the cache table stores the in-frame address of the target image data and either the validity flag or the scheduled access counter having a value of “1” or more, the data request processor can increase the scheduled access counter of that table area by “1”.

The data request processor can read image data of one macroblock required to process the requested image data from one cache area of the cache memory and decrease the scheduled access counter of the table area corresponding to the cache area by “1” when the read image data has been used to process the requested image data.

The image processor successively decodes image data for each frame and the external memory stores image data of a previous frame decoded by the image processor. The data request processor can receive the data request from the image processor requesting image data of the previous frame required to decode image data of a current frame, process the requested image data based on target image data read from the external memory through the cache memory, and output the processed image data to the image processor.

The data request processor can include a Direct Memory Access (DMA) controller that implements DMA transmission of the target image data between the external memory module and the cache memory.

Another aspect of the present invention is a method of controlling memory access for the above memory access control device. The method, which is executable by the data request processor, comprises the steps of receiving a data request including specification of an in-frame occupation region of the requested image data from the image processor, determining target image data of at least one macroblock required to process the requested image data according to the in-frame occupation region of the requested image data, acquiring the target image data from the cache memory, processing the requested image data using the acquired image data, and outputting the processed image data to the image processor.

If the target image data is not stored in the cache memory, selecting one of the table areas having the scheduled access counter with a value of “0” as an update table area, determining whether the cache area corresponding to the update table area is a destination of the target image data, outputting a read request instructing transmission of the target image data from the external memory to the corresponding cache area, and storing the in-frame address of the target image data in the update table area, and increasing the scheduled access counter of the update table area by “1”.

If the target image data is stored in the cache memory and the read request for the target image data has not been output, or if the read request for the target image data has been output, increasing the scheduled access counter of the table area that stores the in-frame address of the target image data by “1”.

When the read image data has been used to process the requested image data, reading the target image data of one macroblock required to process the requested image data from one cache area of the cache memory, and decreasing the scheduled access counter of the table area corresponding to the cache area by “1”.

When the scheduled access counter indicating the number of scheduled accesses to a cache area corresponding to a table area has a value of “1” or more, the table area is not set as an update table area and image data of the cache area corresponding to the table area is not set as image data to be removed. Accordingly, it is possible to prevent image data required to generate image data to be output to the image processor from being set as image data to be removed, thereby reducing the number of generations of read requests.

### BRIEF DESCRIPTION OF THE DRAWINGS

FIG. 1 is a block diagram illustrating a configuration of a moving image decoding module including a memory access control device according to an embodiment of the invention.

FIG. 2 illustrates a compression encoding process of a P frame in a compression procedure for obtaining compressed data that is to be decoded by a moving image decoder of the moving image decoding module.

FIG. 3 illustrates a method of specifying image data in the embodiment.

FIG. 4 is a block diagram illustrating a configuration of the memory access control device.

FIG. 5 is a flowchart showing operation of the memory access control device.

### DETAILED DESCRIPTION OF THE DRAWINGS

Embodiments of the invention will now be described with reference to the drawings.

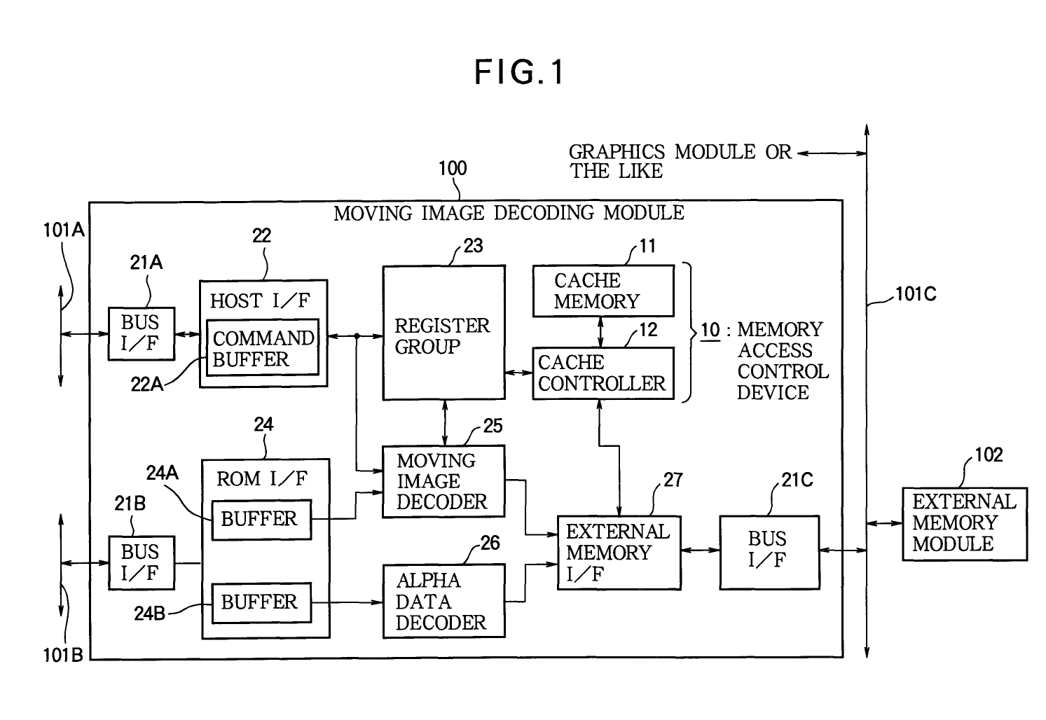

FIG. 1 is a block diagram illustrating a configuration of a moving image decoding module 100 including a memory access control device 10 according to an embodiment of the invention. The moving image decoding module 100 receives a command from a host CPU (not shown) through a bus 101A, reads and decodes compressed image data and compressed alpha data of a moving image from a ROM (not shown) connected to a bus 101B, and stores the decoded image data and alpha data of the moving image in an external memory module 102 including a Synchronous Dynamic Random Access Memory (SDRAM) or the like connected to a bus 101C. In addition to the moving image decoding module 100, a different module such as a graphics module is connected to the bus 101C. The moving image decoding module 100 shares the external memory module 102 with the different module.

Bus interfaces (I/F) 21A, 21B, and 21C in the moving image decoding module 100 are interfaces which mediate data exchange through the buses 101A, 101B, and 101C. A host interface 22 is an interface which receives a command output by a device connected to the bus 101A through the bus interface 21A, and stores the received command in an internal command buffer 22A and provides the command to each associated portion in the moving image decoding module 100. A register group 23 is a group of registers for storing control information for controlling each portion of the moving image decoding module 100 or storing data exchanged between each portion thereof. A ROM interface 24 includes therein buffers 24A and 24B, each of which is a First-In First-Out (FIFO) buffer. The ROM interface 24 receives compressed image data of a moving image read from the ROM (not shown) connected to the bus 101B through the bus interface 21B and stores the compressed image data in the buffer 24A and provides stored compressed image data to a moving image decoder 25 in chronological order. The ROM interface 24 also receives compressed image data of a moving image read from the ROM (not shown) connected to the bus 101B through the bus interface 21B and stores the compressed image data in the buffer 24B and provides stored compressed image data to an alpha data decoder 26 in chronological order.

The moving image decoder 25 is a device that performs a decoding process on compressed image data of a moving image according to a decoding process execution command received through the host interface 22. Here, control information, such as a storage start address in the ROM, of the compressed image data that is to be decoded is stored in a predetermined register of the register group 23 through the host interface 22 before the decoding process is performed. Upon receiving the decoding process execution command, the moving image decoder 25 reads compressed image data, which is to be decoded, from the ROM (not shown) with reference to the control information in the predetermined register and performs a decoding process on the read compressed image data.

In this embodiment, the compressed image data to be decoded by the moving image decoder 25 is obtained through the following compression process. First, independent frames (I frames) to be encoded are selected from constituent frames of a moving image and remaining ones of the constituent frames are selected as predictive frames (P frames) that are to be subjected to inter-frame predictive coding. Image data of each I frame is divided into 16×16 pixel macroblocks and each macroblock is then converted into compressed image data according to a predetermined compression algorithm. Similar to the I frame, image data of each P frame is also divided into macroblocks of 16×16 pixels. Each P frame is subjected to an inter-frame predictive coding process involving motion compensation to generate compressed image data.

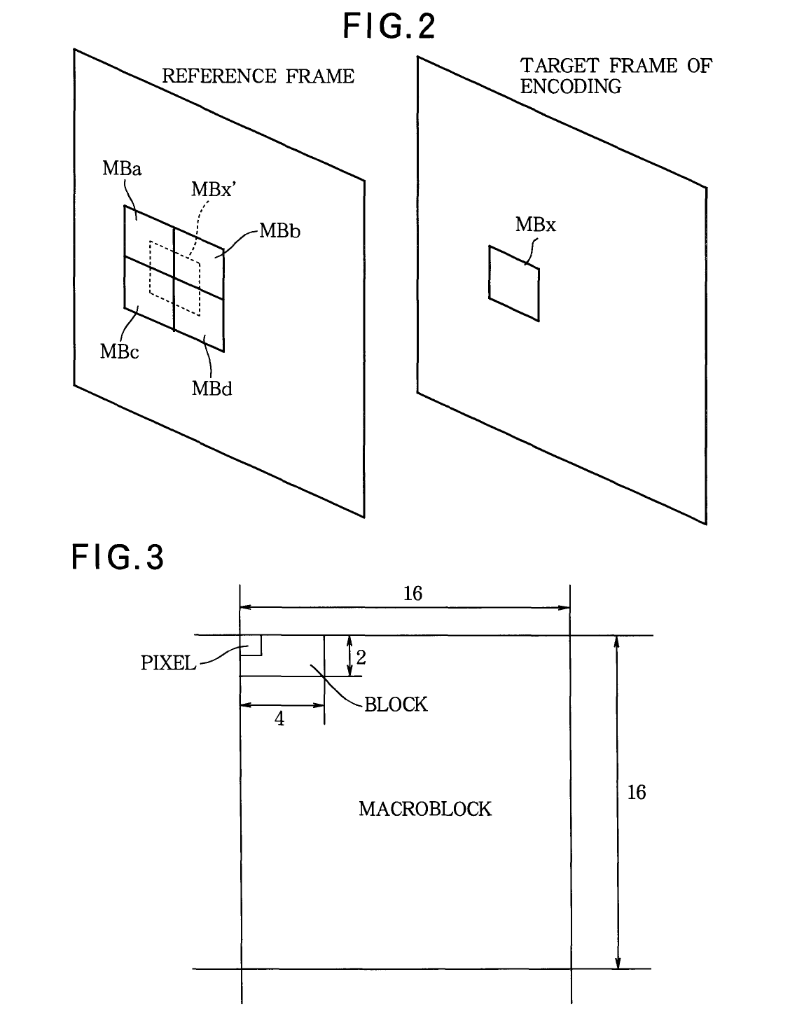

More specifically, in the inter-frame predictive coding process, as illustrated in FIG. 2, a P frame or an I frame prior to the object P frame to be encoded is selected as a reference frame. Then, for each macroblock MBx of the to-be-encoded P frame, a 16×16 pixel region representing an image most similar to an image of the object macroblock MBx is selected as a reference region MBx′ from among image data of the selected reference frame and the difference between image data of the object macroblock MBx and image data of the reference region MBx′ is then compressed. Although the reference region MBx′ covers four macroblocks MBa, MBb, MBc, and MBd of the reference frame in most cases as illustrated in FIG. 2, the reference region MBx′ may also rarely cover 3 or less macroblocks. The moving image decoder 25 receives and decodes the compressed image data of the I and P frames obtained through such a compression process.

Referring back to FIG. 1, the alpha data decoder 26 is a device that performs a decoding process on compressed alpha data of a moving image according to a decoding process execution command received through the host interface 22. Here, control information, such as a storage start address in the ROM, of the compressed alpha data that is to be decoded is stored in a predetermined register of the register group 23 through the host interface 22 before the decoding process is performed. Upon receiving the decoding process execution command, the alpha data decoder 26 reads compressed alpha data, which is to be decoded, from the ROM (not shown) with reference to the control information in the predetermined register and performs a decoding process on the read compressed alpha data.

The external memory interface 27 is an interface that mediates data exchange through the external memory module 102 and each of the moving image decoder 25 and the alpha data decoder 26. In this embodiment, a specific storage region of the external memory module 102 is used as a frame buffer that stores image data decoded by the moving image decoder 25. The external memory interface 27 includes a Direct Memory Access (DMA) controller (DMAC) that implements DMA transmission between the external memory module 102 and the cache memory 11 that is described later.

The following is a description of a P frame decoding process that is performed using the external memory module 102 during the decoding process performed by the moving image decoder 25. The P frame decoding process is performed in units of 16×16 pixel macroblocks, similar to the I frame decoding process. However, the P frame is decoded with reference to image data of a reference region in a reference frame.

The memory access control device 10 included in the moving image decoding module 100 includes a cache memory 11 and a cache controller 12 as a means for providing image data of a reference region to the moving image decoder 25 that performs the P frame decoding process.

When the moving image decoder 25 performs decoding on compressed data of one macroblock of the P frame, the moving image decoder 25 transmits a data request, including specification of an address of a reference region in a reference frame required for the decoding, to the cache controller 12. In this embodiment, each pixel of a frame is specified by both a pixel address X indicating the ordinal number of the pixel in the horizontal direction and a pixel address Y indicating the ordinal number of the pixel in the vertical direction.

The moving image decoder 25 uses block addresses having low resolution rather than pixel addresses as addresses for specifying the reference region. Specifically, in this embodiment, the moving image decoder 25 uses a block address XB obtained by removing the least significant bit of the pixel address X and a block address YB obtained by removing two least significant bits of the pixel address Y as addresses for specifying the reference region. As shown in FIG. 3, the block addresses XB and YB are addresses indicating the horizontal and vertical positions of a corresponding block when the pixels of a frame are divided into blocks, each including 4 horizontal pixels and 2 vertical pixels. In this embodiment, to acquire image data of the reference region in the P frame decoding process, the moving image decoder 25 outputs a data request to the cache controller 12, the data request including block addresses XB and YB of a left upper corner of the reference region, the number of blocks in a horizontal direction in the reference region, and the number of blocks in a vertical direction of the reference region.

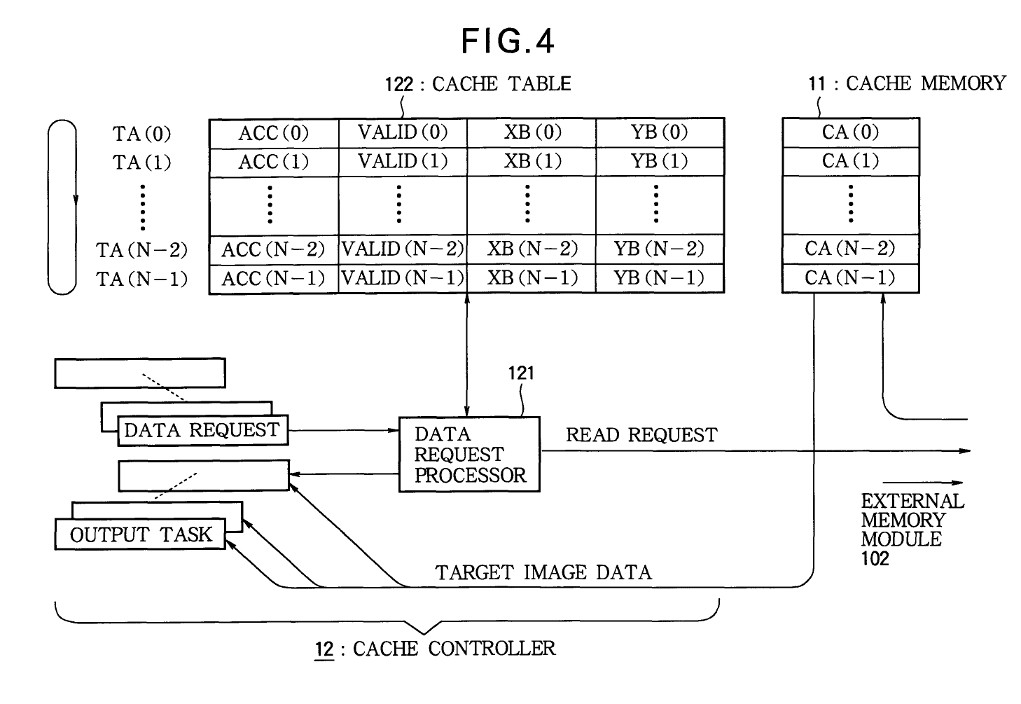

FIG. 4 is a block diagram illustrating a configuration of the cache controller 12 that constructs (i.e., processes) and provides image data of a reference region to the moving image decoder 25 as requested image data according to such a data request. In FIG. 4, the cache memory 11 is also shown for better understanding of the function of the cache controller 12.

In this embodiment, the cache memory 11 includes N (for example, 256) cache areas CA(k) (k=0 to N−1), each being capable of storing image data of one macroblock. Image data of one macroblock read from the frame buffer region of the external memory module 102 is stored in each of the cache areas CA(k) (k=0 to N−1).

A data request processor 121 of the cache controller 12 generates an output task each time a data request is received from the moving image decoder 25. The output task is a task for acquiring, from the cache memory 11, image data of 1 to 4 macroblocks including a reference region specified by the data request and generating image data of the reference region from the acquired image data and outputting the generated image data to the moving image decoder 25. Execution of the output task is paused when the image data of the 1 to 4 macroblocks including the reference region specified by the data request is not stored in the cache memory 11. Execution of an output task is also paused during a period in which a previous output task is outputting image data of a reference region to the moving image decoder 25.

On the other hand, in order that the data request processor 121 generates an output task, the data request processor 121 determines target image data required for the output task to generate image data of a reference region, i.e., image data of 1 to 4 macroblocks covering the reference region. When one of the target image data is not stored in the cache memory 11, the data request processor 121 transmits a request to read the target image data to the external memory module 102 so that the target image data is transmitted from the external memory module 102 to one of the cache areas CA(k) (k=0 to N−1) of the cache memory 11. That is, when data stored in the cache memory 11 is missing some of the target data required by the output task, cache control is performed to compensate for the missing data to enable execution of the output task in this manner.

In this embodiment, a cache table 122 is provided in the cache controller 12 to allow the data request processor 121 to smoothly perform such cache control. The cache table 122 contains N table areas TA(k) (k=0 to N−1) that are associated with the cache areas CA(k) (k=0 to N−1) of the cache memory 11. Here, a scheduled access counter ACC(k), a valid flag VALID(k), and in-frame addresses XB(k) and YB(k) are stored in one table area TA(k). The in-frame addresses XB(k) and YB(k) are block addresses XB and YB of a left upper corner of image data of a macroblock currently stored in the cache areas CA(k) or a left upper corner of image data of a macroblock that is to be read from the external memory module 102 and then stored in the cache areas CA(k). The valid flag VALID(k) is a flag indicating whether or not image data stored in the cache area CA(k) is valid or invalid, and is “1” when the stored image data is valid and “0” when it is invalid. Stated otherwise, the valid flag indicates whether the image data is available or not available from the corresponding cache area. The scheduled access counter ACC(k) is a counter that counts the number of output tasks which require target image data specified by the in-frame addresses XB(k) and YB(k), i.e., the number of scheduled accesses to the cache areas CA(k).

When the data request processor 121 generates each output task, the data request processor 121 monitors data stored in the cache memory 11 based on the contents of the cache table 122 for each generated output task. When target image data required for the output task to generate image data of the reference region is stored in the cache memory 11, the data request processor 121 acquires the target image data from the cache memory 11. When the target image data required for the output task to generate image data of the reference region is not stored in the cache memory 11, the data request processor 121 acquires the required target image data from the cache memory 11 after waiting until the target image data is stored in the cache memory 11. The data request processor 121 then uses the acquired image data to construct the requested image data of the reference region.

Details of cache control that the data request processor 121 performs using the cache table 122 are described as follows. First, the data request processor 121 initializes the contents of the cache table 122 each time an object frame of the moving image decoder 25 is switched. Specifically, the data request processor 121 sets all scheduled access counters ACC(k) (k=0 to N−1) to “0”, all valid flags VALID(k) (k=0 to N−1) to “0” indicating invalidity, and all in-frame addresses XB(k) (k=0 to N−1) and YB(k) (k=0 to N−1) to “0”. Then, each time a data request is provided from the moving image decoder 25, the data request processor 121 generates an output task with image data of 1 to 4 macroblocks including a reference region specified by the data request, as target image data. The data request processor 121 performs the following processes on each of the target image data.

<Process 1>

When there is a need to output a read request for the target image data, the data request processor 121 selects an update table area in the table areas TA(k) (k=0 to N−1), updates the selected update table area, and outputs read request of target image data. The following are details of this process.

First, the data request processor 121 determines whether or not the target image data is stored in the cache memory 11 and whether or not a request to read the target image data has been output. Specifically, the data request processor 121 determines whether or not both the following conditions are satisfied.

Condition a1-1: A table area TA(k), which stores both (1) block addresses XB and YB of a left upper corner of a macroblock to which the target image data belongs as in-frame addresses XB(k) and YB(k) and (2) a valid flag VALID(k) of “1”, is not present.

Condition a1-2: A table area TA(k),which stores both (1) block addresses XB and YB of a left upper corner of a macroblock to which the target image data belongs as in-frame addresses XB(k) and YB(k) and (2) a scheduled access counter ACC(k) having a value of “1” or more, is not present.

When both conditions a1-1 and a1-2 are satisfied, the data request processor 121 selects an update table area from the table areas TA(k) (k=0 to N−1). Specifically, the data request processor 121 increments an index k until a table area TA(k) whose scheduled access counter ACC(k) is “0” is found and determines, when such a table area TA(k) is found, that the table area TA(k) is an update table area. The data request processor 121 determines image data of a cache area corresponding to the update table area is image data to be removed. The data request processor 121 resets the index k to “0” after the index k reaches “N−1”. That is, the data request processor 121 sequentially and cyclically selects each of the table areas TA(k) (k=0 to N-1) as an update table area.

The data request processor 121 then stores block addresses XB and YB of a left upper corner of the target image data as in-frame addresses XB(k) and YB(k) in the update table area TA(k) and also stores a valid flag VALID(k) of “0” indicating invalidity in the update table area TA(k) and increases the value of the scheduled access counter ACC(k) by “1”.

The data request processor 121 then generates a read request which includes the in-frame addresses XB(k) and YB(k) of the target image data and specifies a cache area CA(k) corresponding to the table area TA(k) as a destination of the target image data and then transmits the generated read request to the external memory module 102 through the external memory interface 27 and the bus interface 21C.

<Process 2>

The data request processor 121 increases a scheduled access counter ACC(k) corresponding to the target image data by “1” when a request to read the target image data has been output to the external memory module 102 although the target image data is not yet stored in the cache memory 11. More specifically, when the table areas TA(k) (k=0 to N−1) include a table area TA(k), in which a scheduled access counter ACC(k) having a value of “1” or more, a valid flag VALID(k) of “0” indicating invalidity, and the in-frame addresses XB(k) and YB(k) (k=0 to N−1) of the target image data are stored, the data request processor 121 increases the scheduled access counter ACC(k) in the table area TA(k) by “1”.

<Process 3>

The data request processor 121 increases a scheduled access counter ACC(k) corresponding to the target image data by “1” when the target image data is stored in the cache memory 11. More specifically, when the table areas TA(k) (k=0 to N−1) include a table area TA(k), in which a valid flag VALID(k) having a value of “1” indicating validity and the in-frame addresses XB(k) and YB(k) (k=0 to N−1) of the target image data are stored, the data request processor 121 increases the scheduled access counter ACC(k) in the table area TA(k) by “1”.

The data request processor 121 also performs the following processes.

<Process 4>

When image data of a macroblock is read from the external memory module 102 according to the output read request and is then stored in a cache area CA(k) specified in the read request, the data request processor 121 stores or sets a valid flag VALID(k) of a table area TA(k) associated with the cache areas CA(k) to “1” indicating validity.

<Process 5>

When an output task has read target image data from one cache area (for example, the cache area CA(k1) from among the cache areas CA(k) (k=0 to N−1) and then has used the read target image data to generate requested image data of a reference region, the data request processor 121 decreases a scheduled access counter ACC(k1) of a table area TA(k1) corresponding to the cache areas CA(k1) by “1”.

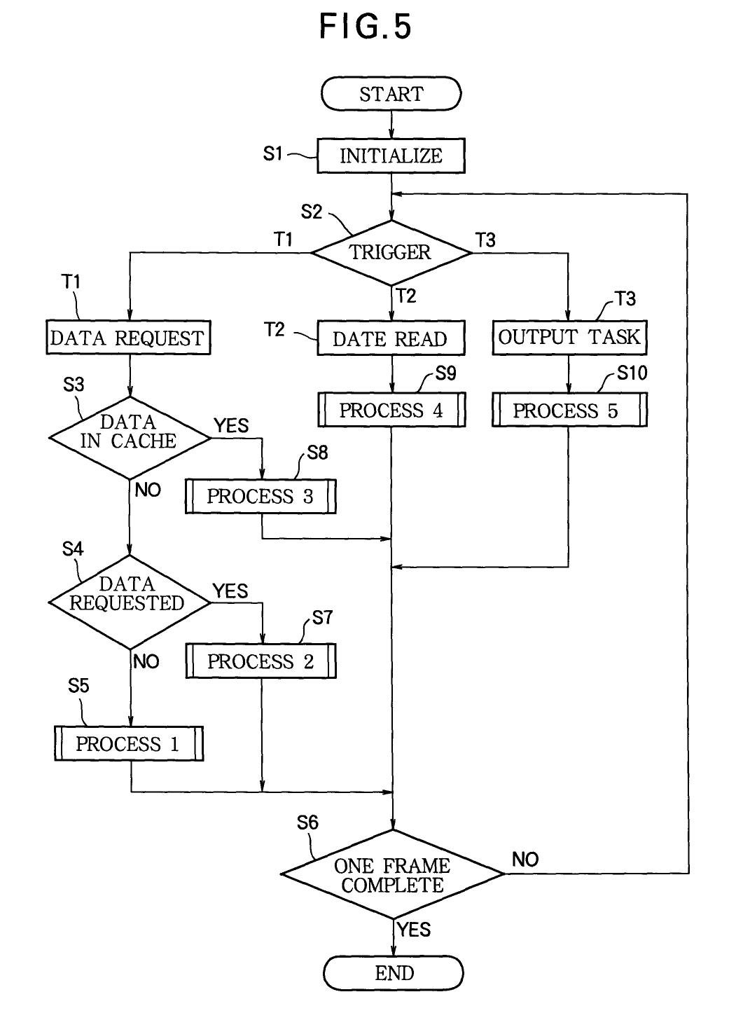

Details of the processes performed by the data request processor 121 are further described below with reference to FIG. 5. The procedure of FIG. 5 executes a flow from start to end each time a frame to be decoded is switched. After start, Step S1 initializes contents of the cache table 122. Specifically, the data request processor 121 sets all scheduled access counters ACC(k) (k=0 to N−1) to “0”, all valid flags VALID(k) (k=0 to N−1) to “0” indicating invalidity, and all in-frame addresses XB(k) (k=0 to N−1) and YB(k) (k=0 to N−1) to “0”.

Then, Step S2 monitors particular triggers T1, T2 and T3 occurring in the data request processor 121. The trigger T1 is a data request from the moving image decoder 25. The trigger T2 is data read from the external memory module 102. The trigger T3 is an output task of data to the moving image decoder 25.

When the trigger T1 occurs, the processes of Step S3 through Step S8 are executed. First, Step S3 determines whether target image data requested from the moving image decoder 25 is present in the cache memory 11. If the target image data is not present in the cache 11, the flow advances to Step S4 to determine whether read request of the target image data to the external memory module 102 is issued.

Namely, in Steps S3 and S4, the data request processor 121 determines whether or not the target image data is not stored in the cache memory 11 and whether or not a request to read the target image data has been output. Specifically, the data request processor 121 determines whether or not both the following conditions are satisfied.

Condition a1-1: A table area TA(k), which stores both (1) block addresses XB and YB of a left upper corner of a macroblock to which the target image data belongs as in-frame addresses XB(k) and YB(k) and (2) a valid flag VALID(k) of “1”, is not present.

Condition a1-2: A table area TA(k), which stores both (1) block addresses XB and YB of a left upper corner of a macroblock to which the target image data belongs as in-frame addresses XB(k) and YB(k) and (2) a scheduled access counter ACC(k) having a value of “1” or more, is not present.

When both conditions a1-1 and a1-2 are satisfied, the flow advances to Step S5 for carrying out the above mentioned process 5. Namely, the data request processor 121 selects an update table area from the table areas TA(k) (k=0 to N−1). Specifically, the data request processor 121 increments an index k until a table area TA(k) whose scheduled access counter ACC(k) is “0” is found and determines, when such a table area TA(k) is found, that the table area TA(k) is an update table area. The data request processor 121 determines image data of a cache area corresponding to the update table area is image data to be removed. The data request processor 121 resets the index k to “0” after the index k reaches “N−1”. That is, the data request processor 121 sequentially and cyclically selects each of the table areas TA(k) (k=0 to N−1) as an update table area.

The data request processor 121 then stores block addresses XB and YB of a left upper corner of the target image data as in-frame addresses XB(k) and YB(k) in the update table area TA(k) and also stores a valid flag VALID(k) of “0” indicating invalidity in the update table area TA(k) and increases the value of the scheduled access counter ACC(k) by “1”.

The data request processor 121 then generates a read request which includes the in-frame addresses XB(k) and YB(k) of the target image data and specifies a cache area CA(k) corresponding to the table area TA(k) as a destination of the target image data and then transmits the generated read request to the external memory module 102 through the external memory interface 27 and the bus interface 21C.

Thereafter, the flow advances to Step S6 to determine whether the data processes of the current frame is completed. When the data processes of one frame is not yet completed, the flow returns to Step S2 for continuously monitoring the particular triggers.

After the request of the target image data to the external memory module 102 has been already outputted and before the target image data requested from the moving image decoder 25 is not yet cached into the cache memory 11, another trigger T1 requesting the same target image data may occur. In such a case, the flow does not advance to Step S5, but branches to Step S7 so as to carry out the above mentioned process 2. Namely, the data request processor 121 increases a scheduled access counter ACC(k) corresponding to the target image data by “1” when a request to read the target image data has been output to the external memory module 102 although the target image data is not yet stored in the cache memory 11. More specifically, when the table areas TA(k) (k=0 to N−1) include a table area TA(k), in which a scheduled access counter ACC(k) having a value of “1” or more, a valid flag VALID(k) of “0” indicating invalidity, and the in-frame addresses XB(k) and YB(k) (k=0 to N−1) of the target image data are stored, the data request processor 121 increases the scheduled access counter ACC(k) in the table area TA(k) by “1”. Thereafter, the flow advances to Step S6 to determine whether the data processes of the current frame is completed. When the data processes of one frame is not yet completed, the flow returns to Step S2 for continuously monitoring the particular triggers.

Then, for example, a trigger T2 occurs in Step S2, and the flow advances from Step S2 to Step S9 where the before mentioned process 4 is performed. Namely, when image data of a macroblock is read from the external memory module 102 according to the output read request and is then stored in a cache area CA(k) specified in the read request, the data request processor 121 stores or sets a valid flag VALID(k) of a table area TA(k) associated with the cache areas CA(k) (k) to “1” indicating validity. Thereafter, the flow advances to Step S6 to determine whether the data processes of the current frame is completed. When the data processes of one frame is not yet completed, the flow returns to Step S2 for continuously monitoring the particular triggers.

Then, in case that a trigger T1 occurs for the image data already stored in the cache memory, the flow advances from Step S3 to Step S8 so as to perform the above mentioned process 3. Namely, the data request processor 121 increases a scheduled access counter ACC(k) corresponding to the target image data by “1” when the target image data is stored in the cache memory 11. More specifically, when the table areas TA(k) (k=0 to N−1) include a table area TA(k), in which a valid flag VALID(k) having a value of “1” indicating validity and the in-frame addresses XB(k) and YB(k) (k=0 to N−1) of the target image data are stored, the data request processor 121 increases the scheduled access counter ACC(k) in the table area TA(k) by “1”. Thereafter, the flow advances to Step S6 to determine whether the data processes of the current frame is completed. When the data processes of one frame is not yet completed, the flow returns to Step S2 for continuously monitoring the particular triggers.

Then, for example, a trigger T3 occurs, and the flow advances from Step S2 to Step S10 where the before mentioned process 5 is carried out. Namely, when an output task has read target image data from one cache area (for example, the cache area CA(k1)) from among the cache areas CA(k) (k=0 to N−1) and then has used the read target image data to generate requested image data of a reference region, the data request processor 121 decreases a scheduled access counter ACC(k1) of a table area TA(k1) corresponding to the cache areas CA(k1) by “1”. By repeating such output tasks, Step S6 finally determines that the processing of one frame is completed, whereby the flow ends. Another flow of FIG. 5 is commenced for a next frame.

In this embodiment, when an output task, in which image data in a cache area CA(k) corresponding to a table area TA(k) is set as target image data, is active and the value of a scheduled access counter ACC(k) indicating the number of scheduled accesses to the cache area CA(k) is “1” or more, the table area TA(k) is not set as an update table area and image data of a cache area CA(k) corresponding to the table area TA(k) is not set as image data to be removed. Accordingly, it is possible to prevent removal of image data required by an active output task, reduce the number of generations of a read request, prevent inhibition of access of another module to the external memory module 102, thereby increasing system efficiency. In addition, a request to read target image data has not been output when in-frame addresses XB(k) and YB(k) of the target image data and a valid flag VALID(k) indicating validity are stored in the cache table 122. Accordingly, it is possible to avoid generation of a redundant read request, thereby realizing efficient image data provision. Further, in this embodiment, even when a valid flag VALID(k) indicating invalidity of target image data is stored in a table area TA(k) in the cache table 122, a request to read the target image data is not output if a scheduled access counter ACC(k) of the table area TA(k) is “1” or more. That is, a request to read the target image data is not output when the target image data is being read from the external memory module 102. Accordingly, it is possible to more reliably prevent redundant read requests.

Further, in this embodiment, since image data in the external memory module 102 are transmitted in units of macroblocks to the cache memory 11, it is possible to increase the probability (i.e., cache hit rate) that, when the moving image decoder 25 has output a data request, target image data for acquiring image data requested by the data request is stored in the cache memory 11, and also to decrease the number of data transmissions between the external memory module 102 and the cache memory 11, thereby increasing system efficiency.

### Other Embodiments

Although the embodiment of the invention has been described above, various other embodiments are possible in the invention. The following are examples.

(1) In the above embodiment, the memory access control device 10 is used as a means for providing image data to the moving image decoder 25. However, the memory access control device 10 may also be used as a means for providing image data to a different type of image processor from the moving image decoder, for example, to a moving image encoder.

(2) There may be a need to read image data of a plurality of macroblocks as a result of the process 1 performed on a plurality of target image data while the image data of the plurality of macroblocks, which need to be read, are also stored in areas of consecutive addresses in the external memory module 102 so that consecutive reading of the image data is possible. In this case, the data request processor 121 may be configured so as to instruct the external memory interface 27 to perform DMA transmission of the image data of the plurality of macroblocks, which can be continuously read, from the external memory module 102 to the cache memory 11. For example, let us assume that, when the moving image decoder 25 performs decoding of the compressed image data of the macroblock MBx shown in FIG. 2, image data of the macroblocks MBc and MBd among the macroblocks MBa, MBb, MBc, and MBd which are target image data are not stored in the cache memory 11 and thus the image data of the macroblocks MBc and MBd need to be read from the external memory module 102. Here, when image data of the macroblock MBc and image data of the macroblock MBd are stored in areas of consecutive addresses in the external memory module 102, the data request processor 121 instructs the external memory interface 27 to perform DMA transmission of the image data of the macroblocks MBc and MBd. In this manner, it is possible to further reduce the number of generations of a read request and a DMA transmission, thereby increasing system efficiency.

1. A memory access control device connectable to an external memory storing image data for processing image data requested by an image processor, the memory access control device comprising:
a cache memory having a plurality of cache areas, each for storing image data of one macroblock, wherein a plurality of predetermined number of macroblocks constitute one frame; and
a cache controller having a cache table and a data request processor,
wherein the cache table has a plurality of table areas, corresponding to the plurality of cache areas, each for storing at least a scheduled access counter that counts the number of scheduled accesses to a corresponding cache area and an in-frame address of image data of one macroblock stored in the corresponding cache area,
wherein the data request processor is programmed to:
receive a data request including specification of an in-frame occupation region of the requested image data from the image processor;
determine target image data of at least one macroblock required to process the requested image data according to the in-frame occupation region of the requested image data;
acquire the target image data from the cache memory; and
process the requested image data using the acquired image data and output the processed image data to the image processor,
wherein if the target image data is not stored in the cache memory, the data request processor is programmed to:
select one of the table areas having the scheduled access counter with a value of “0” as an update table area;
determine whether the cache area corresponding to the update table area is a destination of the target image data;
output a read request instructing transmission of the target image data from the external memory to the corresponding cache area; and
store the in-frame address of the target image data in the update table area and increase the scheduled access counter of the update table area by “1”,
wherein if the target image data is stored in the cache memory and the read request for the target image data has not been output, or if the read request for the target image data has been output, the data request processor is further programmed to increase the scheduled access counter of the table area storing the in-frame address of the target image data by “1”, and
wherein the data request processor is programmed to read the target image data of one macroblock required to process the requested image data from one cache area of the cache memory and decrease the scheduled access counter of the table area corresponding to the cache area by “1” when the read image data has been used to process the requested image data.

2. The memory access control device according to claim 1, wherein:
each of the plurality of table areas further stores a validity flag indicating validity or an invalidity flag indicating invalidity of the image data in the corresponding cache area, and
the data request processor is programmed to select the update table that does not store the validity flag and store the validity flag in the update table area when the target image data has been read from the external memory and stored in the corresponding cache area.

3. The memory access control device according to claim 1, wherein the data request processor includes a Direct Memory Access (DMA) controller that implements DMA transmission of the target image data between the external memory module and the cache memory.

4. The memory access control device according to claim 1, wherein:
the image processor successively decodes image data for each frame and the external memory stores image data of a previous frame decoded by the image processor, and
the data request processor is programmed to receive the data request from the image processor requesting image data of the previous frame required to decode image data of a current frame, process the requested image data based on target image data read from the external memory through the cache memory, and output the processed image data to the image processor.

5. A memory access control device connectable to an external memory storing image data for processing image data requested by an image processor, the memory access control device comprising:
a cache memory having a plurality of cache areas, each for storing image data of one macroblock, wherein a plurality of predetermined number of macroblocks constitute one frame; and
a cache controller having a cache table and a data request processor,
wherein the cache table has a plurality of table areas, corresponding to the plurality of cache areas, each for storing a scheduled access counter that counts the number of scheduled accesses to a corresponding cache area, a validity flag indicating validity or an invalidity flag indicating invalidity of image data in the corresponding cache area, and an in-frame address of image data of one macroblock stored in the corresponding cache area,
wherein the data request processor is programmed to:
receive a data request including specification of an in-frame occupation region of the requested image data from the image processor;
determine target image data of at least one macroblock required to process the requested image data according to the in-frame occupation region of the requested image data;
acquire the target image data from the cache memory;
process the requested image data using the acquired image data and output the processed image data to the image processor,
wherein if any table area in the cache table does not store both the in-frame address of the target image data and the validity flag, and the scheduled access counter thereof does not have a value of “1” or more, the data request processor is programmed to:
select one of the table areas having the scheduled access counter with a value of “0” as an update table area;
the in-frame address of the target image data in the update table area;
increase the scheduled access counter of the update table area by “1”; and
output the read request instructing transmission of the target image data from the external memory to the cache area corresponding to the update table area,
wherein if any table area in the cache table stores the in-frame address of the target image data and either the validity flag or the scheduled access counter having a value of “1” or more, the data request processor is programmed to increase the scheduled access counter of that table area by “1”, and
wherein the data request processor is programmed to read image data of one macroblock required to process the requested image data from one cache area of the cache memory and decrease the scheduled access counter of the table area corresponding to the cache area by “1” when the read image data has been used to process the requested image data.

6. The memory access control device according to claim 5, wherein the data request processor includes a Direct Memory Access (DMA) controller that implements DMA transmission of the target image data between the external memory module and the cache memory.

7. The memory access control device according to claim 5, wherein:
the image processor successively decodes image data for each frame and the external memory stores image data of a previous frame decoded by the image processor, and
the data request processor is programmed to receive the data request from the image processor requesting image data of the previous frame required to decode image data of a current frame, process the requested image data based on target image data read from the external memory through the cache memory, and output the programmed image data to the image processor.

8. A method of controlling memory access for a memory access control device that is connectable to an external memory storing image data for processing image data requested by an image processor, the memory access control device having a cache memory having a plurality of cache areas, each for storing image data of one macroblock, wherein a plurality of predetermined number of macroblocks constitute one frame, and a cache controller having a cache table and a data request processor, wherein the cache table has a plurality of table areas, corresponding to the plurality of cache areas, each for storing at least a scheduled access counter that counts the number of scheduled accesses to a corresponding cache area and an in-frame address of image data of one macroblock stored in the corresponding cache area, the method, which is executed by the data request processor, comprising the steps of:
receiving a data request including specification of an in-frame occupation region of the requested image data from the image processor;
determining target image data of at least one macroblock required to process the requested image data according to the in-frame occupation region of the requested image data;
acquiring the target image data from the cache memory;
processing the requested image data using the acquired image data and outputting the processed image data to the image processor,
wherein if the target image data is not stored in the cache memory, the method comprises the steps of:
selecting one of the table areas having the scheduled access counter with a value of “0” as an update table area;
determining whether the cache area corresponding to the update table area is a destination of the target image data;
outputting a read request instructing transmission of the target image data from the external memory to the corresponding cache area; and
storing the in-frame address of the target image data in the update table area, and increasing the scheduled access counter of the update table area by “1”,
wherein if the target image data is stored in the cache memory and the read request for the target image data has not been output, or if the read request for the target image data has been output, increasing the scheduled access counter of the table area that stores the in-frame address of the target image data by “1”,
wherein when the read image data has been used to process the requested image data, reading the target image data of one macroblock required to process the requested image data from one cache area of the cache memory and decreasing the scheduled access counter of the table area corresponding to the cache area by “1”.
